(19) United States
(12) Patent Application Publication
(10) Pub. No.: US 2006/0174896 A1
(43) Pub. Date: Aug. 10, 2006

(54) Foot brace for enhancing the utility of a user's bed

(76) Inventor: Jordan Dawes, Venice, CA (US)

Correspondence Address: TOPE-MCKAY & ASSOCIATES, 23852 PACIFIC COAST HIGHWAY #311, MALIBU, CA, 90265, US

(21) Appl. No.: 11/054,250

(22) Filed: Feb. 9, 2005

(51) Int. Cl. A61G 15/00

(52) U.S. Cl. 128/845

(57) ABSTRACT

A foot brace is described that provides a user with leverage. The foot brace comprises at least one support member for attaching with a user's bed, with a foot brace member pivotally attached with the support member. The foot brace member has a height, and a planar width with a top portion. The foot brace member is formed such that when the foot brace is attached with a user's bed, the height extends the top portion of the planar width above a mattress portion of the user's bed, allowing a user to place feet against the planar width of the foot brace member to provide a user with leverage when engaging in acts that need leverage or stability.

### BACKGROUND OF THE INVENTION

(1) Technical Field

The present invention relates to a foot brace and, more particularly, to a foot brace for attaching with a bed for providing a user with leverage when engaging in sexual acts or other acts that require stabilization and/or leverage.

(2) Related Prior Art

Throughout history, a bed has been used for sleeping, sexual relations, and as a place to rest for health. In order to enhance a utility of the bed, a variety of apparatus and tools have been conceived. For example, straps and slings are well known and have been used in many activities and have been produced in many forms. Straps and slings have been used in medical offices for medical examinations and in people's homes for medical limb support for recuperation after an injury or surgery. They have also been used during sexual activities to support body parts, such as buttocks, legs, and hands.

Devices have been proposed for use during conjugal relations and are responsive to manipulation or control by a partner to establish a predetermined relation or movement between the partners. Such devices can be used as a novelty, a toy, an enhancer, and an aid. They can also be used when one partner suffers a physical impairment or limitation that otherwise may inhibit or prohibit conjugal relations. Such prior devices include the following:

U.S. Pat. No. 784,425, issued to Phillips, discloses a portable stirrups device which comprises: (1) a flat support surface for placement on a table or bed and for supporting the buttocks of the user; (2) stirrups or foot-rests that are secured to the flat support; and (3) a clamping mechanism for rigidly securing the device to the bed, i.e., for clamping to the side rail of a bed.

U.S. Pat. No. 828,007, issued to Williams, discloses a portable and collapsible operating table that comprises: (1) an intermediate portion for supporting the buttocks/back of a patient and (2) integral and rigid foot rests including heel rests. The device can be placed on a bed or bench or even used as a stretcher.

U.S. Pat. No. 1,894,739, issued to Gilbert, also discloses a portable and collapsible surgical operating table having a foldable central portion for supporting the buttocks or back of the patient and which includes knee rests, rather than foot rests.

U.S. Pat. No. 2,978,713, issued to Scalizitti et al., discloses a portable examining table that comprises a central flat support portion upon which the patient lies and which anchors the table on a bed without the need for any mechanical attachment to the bed (col. 3, lines 5-7). A pair of knee rests are adjustably coupled to respective upstanding side portions.

U.S. Pat. No. 3,227,439, issued to Carlson, discloses an operating table that utilizes leg support portions that pivot about a vertical axis. Similar patents include U.S. Pat. No. 3,227,440, issued to Scott, and U.S. Pat. No. 4,239,200, issued to Sarrafian et al. Stirrups having leg holders that laterally pivot are shown in U.S. Pat. No. 358,513, issued to Walton.

U.S. Pat. No. 3,907,270, issued to Ezzo, discloses a portable examining table that comprises a central flat support for placement on a table with a transverse/bent and leg support member rotatably secured to one end of the flat support. A pair of molded plastic stirrups is fixed on opposite side of the transverse leg support. When the examining table is placed on a table or other surface along with the transverse/bent support member, the patient, with the buttocks on the central portion, can slip their feet into the stirrups.

U.S. Pat. No. 4,940,286, issued to Nguti, discloses a bed attachment that comprises a buttocks support section and having right and left support sections that can pivot in a lateral direction to assist in sexual activity, especially for arm amputees or other handicapped individuals.

U.S. Pat. No. 6,101,652, issued to Matern, Jr., discloses foldable leg stirrups for use during sex or medical examination that can be concealed, after use, between the mattress/box spring of a bed, or under the seat cushion(s) of a couch or chair, or between the mattress/cushion and frame of an examination table.

When engaging in sexual acts, not only may it be desirable to have particular body parts supported, it may also be desirable to increase an individual's leverage, allowing that individual to further stimulate a partner. While the prior art discloses devices for supporting various body parts, it is apparent that none of these devices can be used proximate the bed to provide a user with increased leverage. Thus, there remains a need for a foot brace that can work in accordance with a bed for enhancing the utility of the bed by providing a user with an ability to increase leverage.

### SUMMARY OF THE INVENTION

The present invention relates to a foot brace for attaching with a bed for providing a user with leverage when engaging in sexual acts or other acts that require stabilization and/or leverage. The foot brace comprises at least one support member for attaching with a user's bed, and a foot brace member attached with the support member. The foot brace member includes a height, and a planar width with a top portion. The foot brace is formed such that when the foot brace is attached with a user's bed, the height extends the top portion of the planar width above a mattress portion of the user's bed, allowing a user to place feet against the planar width of the foot brace member to provide a user with leverage when engaging in acts that need leverage or stability.

In another aspect, the foot brace member is pivotally attached with the support member such that the top portion can be pivoted to and from the support member. The pivotal attachment is such that when the top portion is pivoted to the support member, the foot brace is in a substantially planar and compact form allowing for storage of the brace member, and when the top portion is pivoted from the support member, the foot brace member is in an erect position, allowing for placement of a user's feet.

In yet another aspect, the foot brace member further comprises two halves pivotally attached with each other, such that when the top portion is pivoted to the support member, and when the two halves are pivoted towards each other, the foot brace is in a compact position allowing for storage. Additionally, the foot brace member is formed as a rigid frame and further comprises a sheet attached with the rigid frame, allowing user's feet to be placed against the sheet.

In another aspect, the support member includes a length and at least two sections. The two sections are connected with one another such that the length of the support member may be altered by telescoping the two sections in relation to one another.

In yet another aspect, the present invention further comprises at least one attachment apparatus attached with the foot brace member. The at least one attachment apparatus is formed to be connected with an attachment, whereby the attachment can be connected with a bed leg to further stabilize the foot brace when attached with a user's bed, or with a user to secure the user proximate the foot brace.

Additionally, the present invention further comprises an attachment for connecting with the attachment apparatus. The attachment is an elongated flexible device for securing the foot brace with a bed leg to stabilize the foot brace.

In another aspect, the top portion of the foot brace member includes an arcuate-shaped section to conform with a shape of a user's foot.

In yet another aspect, the present invention further comprises a body strap for connecting with the foot brace, whereby the body strap may be used to secure a user proximate the foot brace to hold the user in place while engaging in sexual acts with a partner.

Finally, it can be appreciated by one in the art that the above summary of the foot brace is not meant to be limiting and can be applied to various aspects of the present invention, such as a kit and method for building and using the same, where each individual part is configured to be connected with the respective connecting part.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1 is an illustration of a foot brace according to the present invention;

FIG. 2 is an illustration of a foot brace of the present invention, in a folded and compact position, allowing for easy storage;

FIG. 3 is an illustration of a sheet attached with a foot brace according to the present invention; and

FIG. 4 is an illustration of a foot brace attached with a user's bed according to the present invention.

### DETAILED DESCRIPTION

The present invention relates to a foot brace and, more particularly, to a foot brace for attaching with a bed for providing a user with leverage when engaging in sexual acts.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

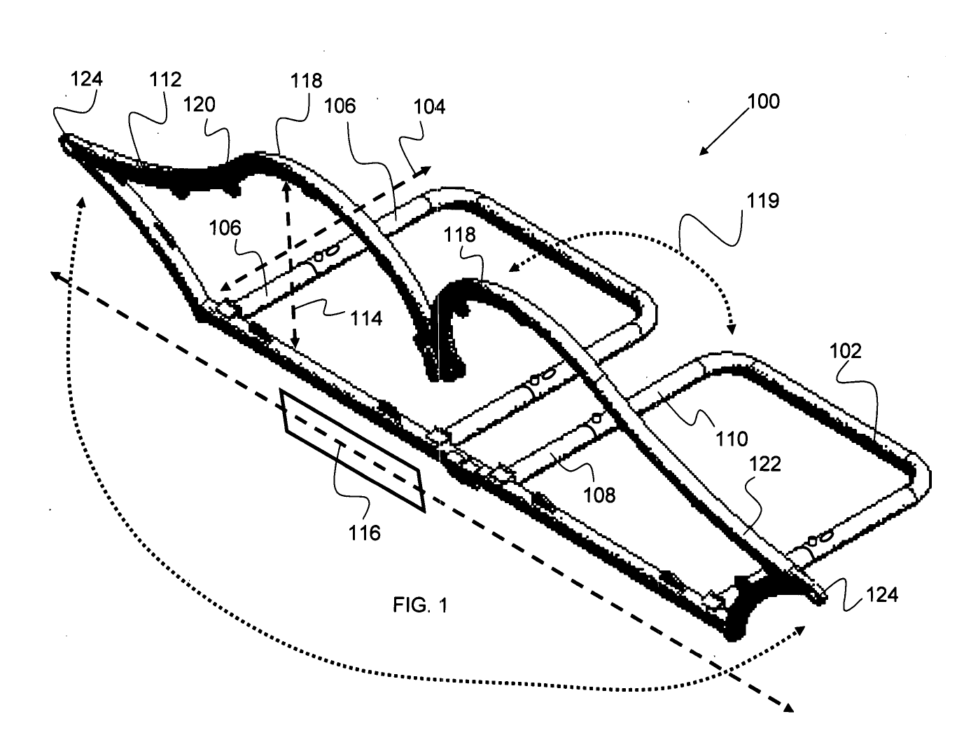

Referring now to the figures, FIG. 1 illustrates a foot brace 100 according to the present invention. The foot brace 100 comprises at least one support member 102 for attaching with a user's bed. The support member 102 is formed in any suitable form to create a length 104 that can be positioned between a mattress and a box spring. For example, the support member 102 may be a planar sheet, a tubular rod, or at least two telescoping sections 106. When the support member is formed of two telescoping sections 106, the two sections 106 are connected with one another such that the length 104 of the support member 102 may be altered by telescoping the two sections 106 in relation to one another. For example, the two sections 106 may be tubular rods where a first section 108 slides within a second section 110, thereby allowing the length 104 of the support member 102 to be altered.

A foot brace member 112 is attached with the support member 102. The foot brace member 112 includes a height 114 and a planar width 116 with a top portion 118. The foot brace member 112 is formed such that when the foot brace 100 is attached with a user's bed (by positioning the support member 102 below a user's mattress), the height 114 extends the top portion 118 of the planar width 116 above the user's mattress. When attached with a mattress, the foot brace member 112 allows a user to place their feet against the planar width 116 of the foot brace member 112 to provide the user with leverage when engaging in sexual acts or other acts that need leverage or stability. Additionally, both the support member 102 and the foot brace member 112 are formed of a suitably rigid and durable material, non-limiting examples of which include metal and plastic.

The foot brace member 112 may be attached with the support member 102 such that it may be fixedly positioned in relation to the support member 102, or such that it is pivotally attached with the support member 102. When pivotally attached with the support member 102, the top portion 118 can be pivoted toward and away from the support member 102. When the top portion 118 is pivoted to the support member 102, the foot brace 100 is in a substantially planar and compact form.

It is important to note that the pivotal attachment between the support member 102 and the foot brace member 112 is formed such that a stop is included to prevent the top portion 118 from pivoting beyond a usable angle 119 from the support member 102. A user's feet will ultimately be placed upon the foot brace member 112 and, as such, the foot brace member 112 cannot extend beyond the useable angle 119. As a non-limiting example, the pivotal attachment allows the foot brace member 112 to pivot between 0 degrees and 110 degrees (i.e., usable angle 119) in relation to the support member 102, with the pivotal attachment preventing the foot brace member 112 from pivoting beyond 110 degrees.

Additionally, the foot brace member 112 may optionally include two halves (i.e., a first half 120 and a second half 122) pivotally attached with each other, where outer portions 124 of the first half 120 and the second half 122 may be brought together through the pivotal attachment.

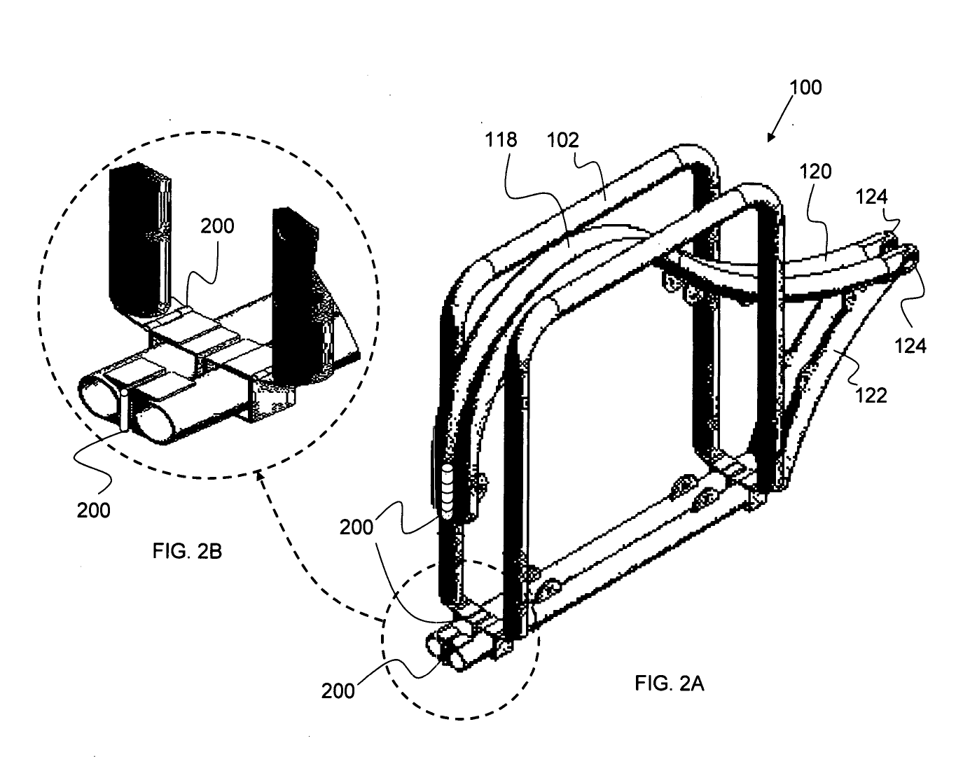

As shown in FIG. 2A, when the top portion 118 is pivoted toward the support member 102, and when the outer portions 124 of the first half 120 and the second half 122 are pivoted towards each other, the foot brace 100 is in a compact position allowing for easy storage. The pivotal attachments described herein are formed through any suitable mechanism or device for creating a pivotal attachment between two objects. As a non-limiting example, and as shown in FIG. 2A, a plurality of hinges 200 are used to form the pivotal relationships described herein. Additionally, FIG. 2B illustrates a blown-up section of FIG. 2A, further illustrating exemplary pivotal attachments (e.g., hinges 200) according to the present invention.

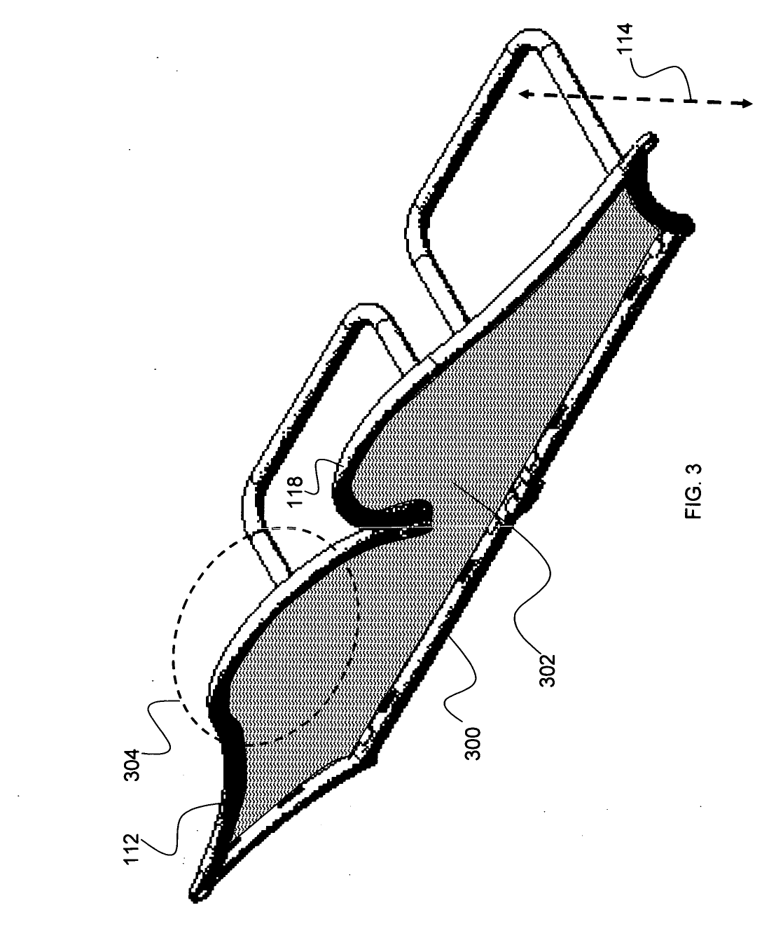

The foot brace member 112 may be formed from a variety of materials and in a variety of shapes to form the height 114 and planar width 116. For example, the foot brace member may be formed of sheet metal to provide a bracing surface. As another non-limiting example, and as shown in FIG. 3, the foot brace member 112 may be formed as a rigid frame 300 with a sheet 302 attached with the rigid frame 300. The sheet 302 may be formed of any suitable material to provide a bracing surface, non-limiting examples of which include sheet metal and durable fabric, such as the fabric used in a trampoline. As applicable to its respective material, the sheet 302 is attached with the rigid frame 300 through any suitable attachment technique, non-limiting examples of which include being riveted, wielded, and screwed. Once attached, a user may place their feet against the sheet 302 for leverage.

Additionally, the top portion 118 may optionally include at least one arcuate-shaped section 304 to increase the height 114 of the foot brace member 112. The arcuate-shaped section 304 provides an increased surface area for a user's foot (because a foot takes an elongated form), while minimizing material costs. Additionally, by including the arcuate-shaped section 304, the foot brace 100 can accommodate feet of varying lengths, and increase its strength due to strengthening properties of arch shapes. The arcuate-shaped section 304 is formed in the foot brace member 112 such that its position is optimized with respect to the position of a user's foot. Because a user has two feet and is likely going to be positioned in the middle of a bed, the arcuate-shaped section 304 is formed at the location where a user's foot is likely going to be.

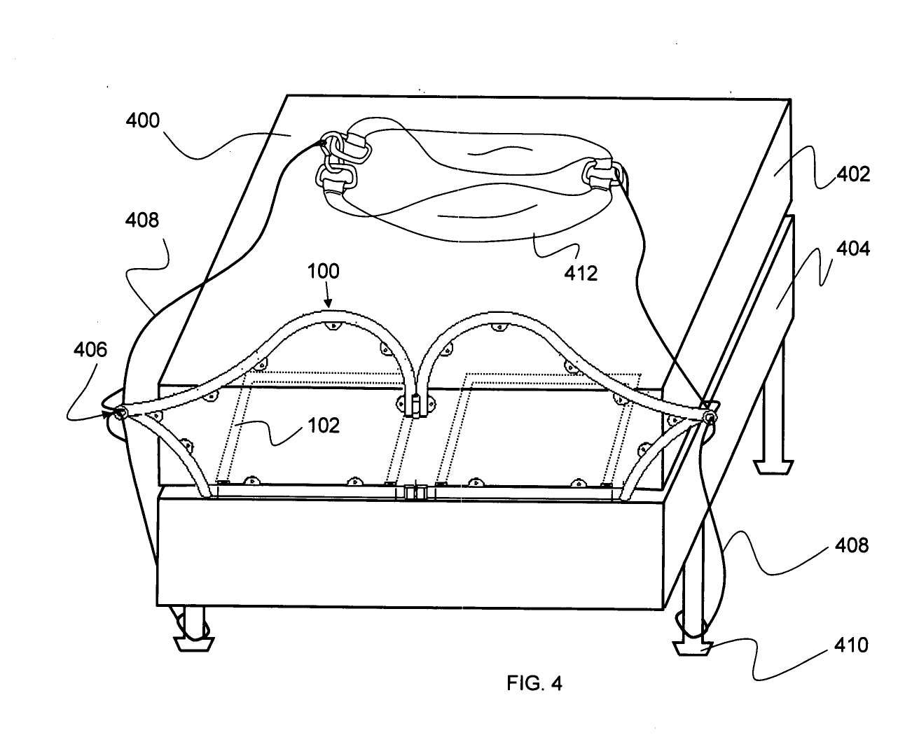

FIG. 4 illustrates the foot brace 100 attached with a user's bed 400. As shown in FIG. 4, the support member 102 is positioned between a user's mattress 402 and box spring 404. To further support and stabilize the foot brace 100, at least one attachment apparatus 406 is attached with the foot brace member 112. The attachment apparatus 406 is formed to be connected with an attachment 408, where the attachment 408 can be connected with a bed leg 410 to further stabilize the foot brace 100 when attached with a user's bed 400. The attachment apparatus 406 is formed in any suitable shape or manner to allow for connection of the attachment 408, non-limiting examples of which include a loop and hook. The attachment 408 is any elongated device for securing the foot brace 100 with the bed leg 410. As a non-limiting example, the attachment 408 may be a flexible chain or strap.

In another aspect, a body strap 412 may be used to secure a user proximate the foot brace 100. By securing the user proximate the foot brace 100, the user is held in place and not pushed away while engaging in sexual acts with a partner. The body strap 412 may be substantially elongated (not shown in FIG. 4) to be connected directly to the foot brace 100, or may be connected with the foot brace 100 through an attachment 408.

In summary, as can be appreciated by one in the art, the invention described herein allows a user to secure the foot brace 100 with a bed 400 so that the user may place feet upon the foot brace 100 to gain leverage and/or stability.

What is claimed is:

1. A foot brace for enhancing the utility of a user's bed, comprising:
a support member for attaching with a user's bed;
a foot brace member attached with the support member, the foot brace member having a height, and a planar width with a top portion, and being formed such that when the foot brace is attached with a user's bed, the height extends the top portion of the planar width above a mattress portion of the user's bed, allowing a user to place their feet against the planar width of the foot brace member to provide a user with leverage when engaging in acts that need leverage or stability.

2. A foot brace as set forth in claim 1, wherein the foot brace member is pivotally attached with the support member, such that the top portion can be pivoted toward and away from the support member, such that when the top portion is pivoted to the support member, the foot brace is in a substantially planar and compact form allowing for storage of the brace member, and when the top portion is pivoted from the support member, the foot brace member is in an erect position, allowing for placement of a user's feet thereon.

3. A foot brace as set forth in claim 2, wherein the foot brace member further comprises two halves pivotally attached with each other, such that when the top portion is pivoted to the support member, and when the two halves are pivoted toward each other, the foot brace is in a compact position allowing for storage.

4. A foot brace as set forth in claim 3, wherein the foot brace member is formed as a rigid frame, and further comprising a sheet attached with the rigid frame, allowing user's feet to be placed against the sheet.

5. A foot brace as set forth in claim 4, wherein the support member includes a length and at least two sections, wherein the two sections are connected with one another such that the length of the support member may be altered by telescoping the two sections in relation to one another.

6. A foot brace as set forth in claim 5, further comprising an attachment apparatus attached with the foot brace member, the attachment apparatus being formed to be connected with an attachment, whereby the attachment can be connected with a bed leg to further stabilize the foot brace when attached with a user's bed.

7. A foot brace as set forth in claim 6, further comprising an attachment for connecting with the attachment apparatus, the attachment being an elongated flexible device for securing the foot brace with a bed leg to stabilize the foot brace.

8. A foot brace as set forth in claim 7, wherein the top portion of the foot brace member includes an arcuate-shaped section to conform with a shape of a user's foot.

9. A foot brace as set forth in claim 8, further comprising a body strap for connecting with the foot brace, whereby the body strap may be used to secure a user proximate the foot brace to hold the user in place.

10. A foot brace as set forth in claim 1, wherein the foot brace member further comprises two halves pivotally attached with each other, such that when the top portion is pivoted to the support member, and when the two halves are pivoted toward each other, the foot brace is in a compact position allowing for storage.

11. A foot brace as set forth in claim 1, wherein the foot brace member is formed as a rigid frame, and further comprising a sheet attached with the rigid frame, allowing user's feet to be placed against the sheet.

12. A foot brace as set forth in claim 1, wherein the support member includes a length and at least two sections, wherein the two sections are connected with one another such that the length of the support member may be altered by telescoping the two sections in relation to one another.

13. A foot brace as set forth in claim 1, further comprising an attachment apparatus attached with the foot brace member, the attachment apparatus being formed to be connected with an attachment, whereby the attachment can be connected with a bed leg to further stabilize the foot brace when attached with a user's bed.

14. A foot brace as set forth in claim 13, further comprising an attachment for connecting with the attachment apparatus, the attachment being an elongated flexible device for securing the foot brace with a bed leg to stabilize the foot brace.

15. A foot brace as set forth in claim 1, wherein the top portion of the foot brace member includes an arcuate-shaped section to conform with a shape of a user's foot.

16. A foot brace as set forth in claim 1, further comprising a body strap for connecting with the foot brace, whereby the body strap may be used to secure a user proximate the foot brace to hold the user in place.

17. A method for forming a foot brace for enhancing the utility of a user's bed, comprising acts of:
forming a support member for attaching with a user's bed;
forming and attaching a foot brace member with the support member, the foot brace member having a height, and a planar width with a top portion, and being formed such that when the foot brace is attached with a user's bed, the height extends the top portion of the planar width above a mattress portion of the user's bed, allowing a user to place feet against the planar width of the foot brace member to provide a user with leverage when engaging in acts that need leverage or stability.

18. A method for using a foot brace for enhancing the utility of a user's bed, comprising acts of:
attaching a support member with a user's bed, where a foot brace member is attached with the support member, the foot brace member having a height, and a planar width with a top portion, and being formed such that when the foot brace is attached with a user's bed, the height extends the top portion of the planar width above a mattress portion of the user's bed; and
placing feet against the planar width of the foot brace member to provide a user with leverage when engaging in acts that need leverage or stability.

19. A kit for building a foot brace for enhancing the utility of a user's bed, the kit comprising:
a support member for attaching with a user's bed;
a foot brace member configured to be attached with the support member, the foot brace member having a height, and a planar width with a top portion, and being formed such that when the foot brace is attached with a user's bed, the height extends the top portion of the planar width above a mattress portion of the user's bed, allowing a user to place feet against the planar width of the foot brace member to provide a user with leverage when engaging in acts that need leverage or stability, and where the foot brace member further includes an attachment apparatus configured to further enable securing of the foot brace with a user's bed.

20. A kit for building a foot brace as set forth in claim 19, further comprising an attachment for connecting with the attachment apparatus, the attachment being an elongated flexible device, whereby the attachment can be connected with a bed leg to further stabilize the foot brace when attached with a user's bed, allowing a user to place feet upon the foot brace member and thereby increase leverage.

21. A foot brace for enhancing the utility of a user's bed, comprising:
a support member for attaching with a user's bed;
wherein the support member includes a length and at least two sections, wherein the two sections are connected with one another such that the length of the support member may be altered by telescoping the two sections in relation to one another;
a foot brace member attached with the support member, the foot brace member having a height, and a planar width with a top portion, and being formed such that when the foot brace is attached with a user's bed, the height extends the top portion of the planar width above a mattress portion of the user's bed, allowing a user to place feet against the planar width of the foot brace member to provide a user with leverage when engaging in acts that need leverage or stability;
wherein the foot brace member is pivotally attached with the support member, such that the top portion can be pivoted to and from the support member, such that when the top portion is pivoted to the support member, the foot brace is in a substantially planar and compact form;
wherein the foot brace member further comprises two halves pivotally attached with each other, such that when the top portion is pivoted to the support member, and when the two halves are pivoted towards each other, the foot brace is in a compact position allowing for storage;
wherein the foot brace member is formed as a rigid frame, and further comprising a sheet attached with the rigid frame, allowing user's feet to be placed against the sheet;
wherein the top portion of the foot brace member includes an arcuate-shaped section to conform with a shape of a user's foot;
an attachment apparatus attached with the foot brace member, the attachment apparatus being formed to be connected with an attachment; and
an attachment for connecting with the attachment apparatus, the attachment being an elongated flexible device, whereby the attachment can be connected with a bed leg to further stabilize the foot brace when attached with a user's bed, allowing a user to place feet upon the foot brace member and thereby increase leverage.
